(19) United States
(12) Patent Application Publication
(10) Pub. No.: US 2019/0279537 A1
(43) Pub. Date: Sep. 12, 2019

(54) SPLIT RING INFORMATION TAG

(71) Applicant: Danny Heinzlmeir, Strathmore (CA)

(72) Inventor: Danny Heinzlmeir, Strathmore (CA)

(21) Appl. No.: 15/917,888

(22) Filed: Mar. 12, 2018

(51) Int. Cl. G09F 3/06; B65D 51/24; G09F 3/02

(52) U.S. Cl. CPC G09F 3/06; G09F 2003/0251; G09F 3/02; B65D 51/245

(57) ABSTRACT

An information baring tag providing the means of conveying product information, concerning a product filled cartridge inserted into its dispensing device, to the user of said device. The tag is detachably attached to the cartridge and consists of an inner and outer circular plane surface that forms a cylindrical ring. A single weakened line extends from the top circular plane edge to bottom circular plane edge which can be broken, either by hand or mechanical cutting appliance, to form a split across the circular plane surface. This split enables the tag to be expanded, allowing for placement onto a dispensing device and is held in place by the tags natural tendency to return to its original shape, thereby gripping the dispensing device. Once placed, the tag can be referenced by the user for product identification and important information which would otherwise have been concealed.

### FIELD OF THE INVENTION

The present invention relates to product cartridges and, more particularly, to an information tag for product cartridges.

### BACKGROUND OF THE INVENTION

Product cartridges and dispensing guns, such as, for example, grease guns and grease gun cartridges are widely used in industry to apply lubricant to a wide variety of mechanical devices. There are many brands and chemical compositions of lubricant to choose from, depending on the application. Mechanic shops would typically have multiple types of grease and multiple grease guns for different applications. Once the cartridge is inserted into the dispenser it is not easily transferable to another grease gun and the cartridge typically remains in the gun until empty.

While the various manufacturers provide product information on the cartridges they sell, once the cartridge is inserted into its dispensing device, said cartridge is obscured by the barrel of the device and no longer available for reference by the user. The identity of the product is concealed, leading to the possibility of using the wrong product for the application. Accordingly, there is a need and desire to be able to identify the cartridge contents or product after the cartridge has been inserted into a dispensing gun.

### SUMMARY OF THE INVENTION

Embodiments of the present invention provide a solution to the foregoing problems existing in the field. In one aspect, a split ring information tag is provided that relates to the availability of product information for products wholly or partially obscured by their dispensing device. With the present invention, when a new cartridge is inserted into its dispensing device, the split ring information tag is removed from the cartridge, split and applied to the barrel of the device. The dispensing device now has an identification and information baring tag providing the user with knowledge of the product being applied.

In today's workplace and with the importance placed on workplace safety, it is important that employers provide their employees with the knowledge required to properly use a product and protect employees from any hazards posed by the product. Often materials that are placed in secondary containers require additional labeling, like those used for controlled products. In embodiments, the split ring information tag provides a device that can be used to perform this function. Manufacturers can print safety related information directly to the tag and satisfy health and safety labeling requirements for users of the product.

In embodiments, the split ring information tag also allows manufacturers and end users to advertise the product used. Manufacturers can print their name on the tag; increasing brand visibility. With the tag applied to the dispensing device, clients to a business can see quality products are used by the business as the tags identify the product and the manufacturer of the product.

Cartridges are typically sold as they are; individual tubes with all the necessary product information printed on the tube and no external packaging. The split ring information tag is conveniently formed to slide onto the cartridge as a separate, individual piece or to be part of a multipurpose closure cap. For example, the present invention may be used in addition to existing closures, like the one described in U.S. Patent Number 5,722,562, to add further function to the cap and reduce waste associated with manufacturing an additional item. The cap is produced with the weakened line between the caps circular plane edges as well as an additional weakened line, around the cap, where cap end and the corresponding circular plane edge meet, enabling separation of the two pieces to form the ring and a disposable cap end. The ring can then be further separated to enable placement on the dispensing device. With the push for less packaging, it makes sense to reuse the end cap for the tag and eliminate any additional manufacturing processes or material used for its production.

In an aspect, the tag has a circular plane surface forming a cylindrical shape extending along the outside surface of the cartridge wall and installed on the cartridge as a convenient method of supplying it to the end user. Perpendicular to the cylindrical edge is a single thinner weakened line in the cap material, extending from top to bottom. Once removed from the cartridge, this line can either be torn by hand or cut by mechanical means to split the circular plane surface allowing the tag to be open and spread for placement onto the dispenser. As the tag was molded to fit the form of the cartridge, the tag has a natural tendency to want to return to its original circular shape, essentially gripping the dispensing device ensuring a secure attachment. Once placed, the information tag is readily available to provide product knowledge to the end user.

Similarly, the present invention as described can be formed as part of the cartridge end cap.

End caps are required to ensure product in the tube does not leak out or become contaminated by debris when shipped to retailers or end users. As the cartridge is readied to be inserted into its dispensing device, the end cap is removed as it has served its purpose and is no longer needed. By altering the end cap with two weakened lines, the cap can be used to form the information tag. The first weakened line extends perpendicular to the circular plane edge of the cap skirt from top to bottom and the second follows the skirt edge, where cap edge and cap end meet. By first separating the shorter perpendicular weakened line, then continuing to separate skirt from cap end, the tag is formed. The tag can then be attached to the dispensing device. Other objects and features of this invention will be in part apparent and in part pointed out hereinafter.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a perspective view of a split ring information tag constructed in accordance with an embodiment of the present invention, shown on a product cartridge (shown in phantom) prior to the tag being split;

FIG. 2 is a perspective view of the split ring information tag of FIG. 1, shown after being removed from the product cartridge and split;

FIG. 3 is a cross sectional view of a split ring information tag having a detachable cap end, shown attached to the end of a product cartridge (shown in phantom);

FIG. 4 is a perspective view of the split ring information tag separated into its two parts, forming a tag and a cap end;

FIG. 5 is a plan view of the split ring information tag, showing the tag in a flattened state and illustrating example graphic content; and

FIG. 6 is a perspective view of the split ring information tag, show in use on a product cartridge that is installed into a dispensing gun to provide information about a product contained within the product cartridge.

### DETAILED DESCRIPTION OF THE INVENTION

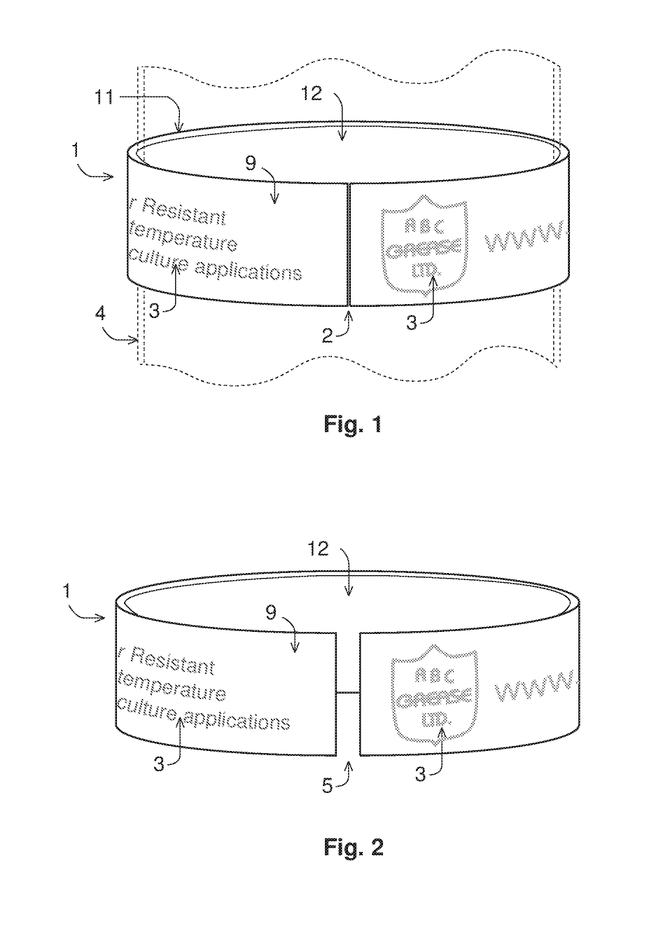

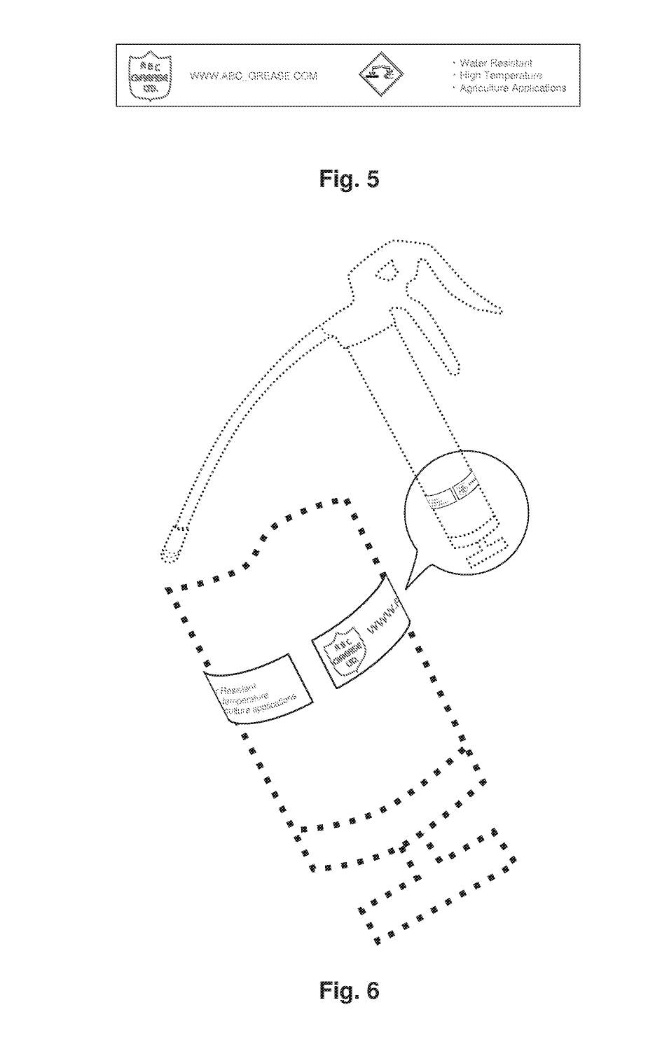

Referring now to FIGS. 1 through 6 of the drawings a split Ring Information tag 1 as it is attached to a cartridge 4 prior to being split along the perpendicular line 2 for application to a dispensing device (shown in FIG. 1). The tag 1 is molded of a flexible and resilient material, such as high-density polyethylene (HDPE). Thinned areas 2 and 8 within the molded material, allow the cylindrical ring 11 to be cut by mechanical means or torn by hand, to form the tag and allow for expansion for placement on a dispensing device. As the flexible nature of the tag material allows for expansion of the tag, the resilient nature of the material results in the expanded tag wanting to return to its original molded shape and close the gap formed at 5. This characteristic results in the tag gripping the dispensing device as it tries to recover its original shape, thereby providing secure attachment to said device (example FIG. 6).

Also shown in FIG. 2, graphics and information 3 are applied to the ring's outer circular plane surface 9. This information could include product manufacturer, safety recommendations, applications, composition, and/or characteristics, to name a few. Once the split ring information tag is attached to the dispensing device, all that information is made available to the user or anyone viewing the device. The user now knows, for example, what product is being used and any appropriate safety precautions to take. The tag also allows for branding of the product, showcasing the quality products used in a business establishment. Furthermore, as workplace safety has become prominent in business with ever increasing government health and safety regulation, it is of utmost importance that employer's provide the appropriate information concerning products used by employees.

Manufacturers are always looking for ways to differentiate their products from their competitors. The Split Ring Information Tag provides a valuable method of marketing their product and will stand out when on the shelf next to similar products. The tag is visibly identifiable on store shelves as an innovative improvement with no similar method of conveying product information currently available; catching the consumers eye with flashy graphics, overall usefulness and the innovative aspect of the tag.

The present invention improves upon current methods used for conveying product information of products in a cartridge, such as, for example a transparent grease gun described in U.S. Published Patent Application No. 20070210108A1. The transparent nature of the grease gun, allows the product information on the cartridge to be viewed through the transparent cartridge holder of the dispensing device. Anyone who has used a grease gun knows that grease gets everywhere inside the cartridge holder and out, resulting in obscuring the product information inside a transparent device. With the split ring information tag, the tag is compact, occupies a small footprint and can be easily avoided when handling the dispensing device, allowing important information to be readily available to the user. The Split Ring Information Tag can also be used on any type of dispenser, transparent or not, including new cordless power-driven units.

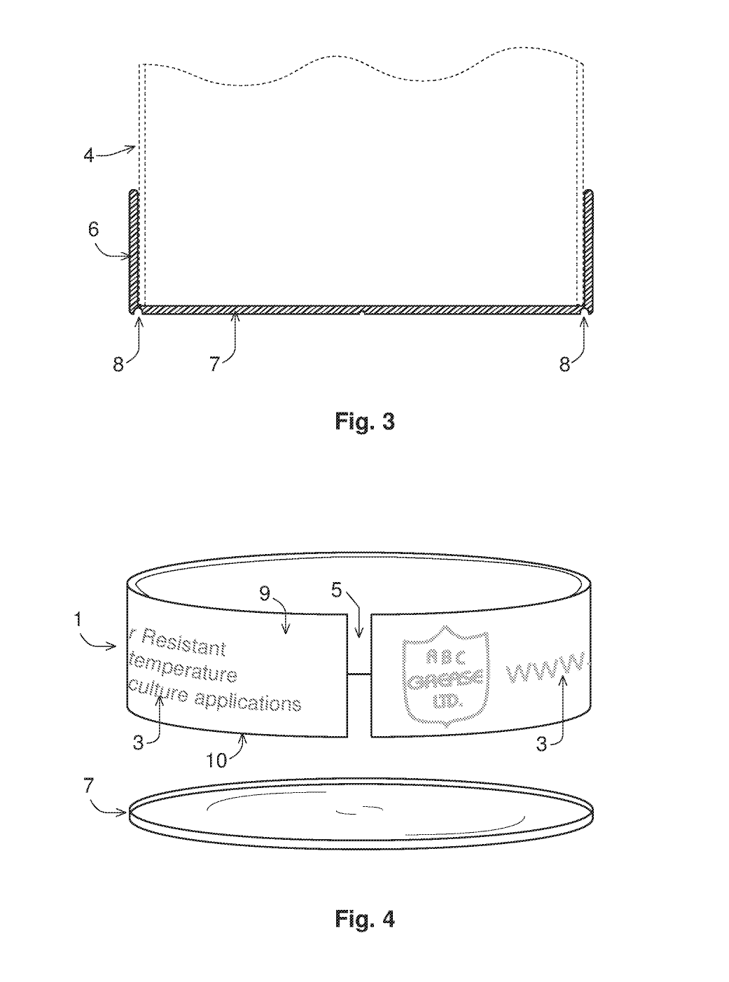

For convenient shipment to the customer, the tag is supplied on the cartridge as a separate sleeve, as in FIG. 1, or part of a multipurpose closure cap, as in FIG. 3 and FIG. 4. The detachably attached tag can be removed prior to inserting the cartridge into its dispensing device and readied for attachment to the dispensing device. Weakened lines 2 and 8 are provided for transforming the sleeve or cap into the information baring tag. The weakened lines can be torn by hand or used as a guide to cut by mechanical means, thus creating the split ring tag. The weakened lines need to be thin enough to tear by hand but robust enough to withstand the forces of the manufacturing process and application to the product filled cartridge.

After removal from the cartridge and separation of the ring along the weakened line or lines, the user has formed a split in the ring 5 as shown in FIG. 2 and FIG. 4. The tag, with product information 3 on the tags circular plane surface 9, is ready for application to the dispensing device, as in FIG. 6, a grease gun (shown in phantom).

FIG. 3 shows a cross sectional view of the tag as it appears on the bottom of a cartridge 4 with end cap; as part of a multipurpose closure cap. The cap is first used as a cartridge closure cap to protect the product inside and secondly as the information tag, once separated from the cap end 7. The multipurpose closure cap has two weakened lines. The first line 9 is used to split the circular plane surface enabling separation to form the split ring 1. The second line 8 is used to separate the split ring from the end cap 7 along the tags circular plane edge 10. Once separated as required the user is left with the disposable cap end 7 and information tag 1 ready for application to the dispensing device. Producing the Split Ring Information Tag as part of the multipurpose closure cap reduces waste and additional processes associated with supplying; the tag as a separate item, added to the cartridge. In today's culture of reduce, reuse and recycle, the information tag provides for innovation with additional uses for an otherwise single use cartridge end cap.

As various changes could be made in the drawings without departing from the scope of the invention, it is intended that all matter contained in the above description or shown in the accompanying drawings shall be interpreted as illustrative and not in a limiting sense.

What is claimed is:

1. A closure cap adapted for insertion on an extremity of a cartridge, said cartridge adapted for insertion onto a dispensing device, said closure cap comprising:
a resilient cylindrical sleeve having a length adapted to display information, a first end, a second end, a predetermined split mark defining a first sleeve extremity and a second sleeve extremity, and a circular plane surface;
wherein the first end of the cylindrical sleeve is removably attached to an edge of the circular plane surface; and
wherein once the circular plane surface is removed from the cylindrical sleeve, the first sleeve extremity can be separated from the second sleeve extremity at the predetermined split mark and attached around a circumference of the dispensing device.

2. The closure cap according to claim 1, wherein the predetermined split mark can be separated manually or by cutting with a mechanical apparatus.

3. The closure cap according to claim 2, wherein the resilient cylindrical sleeve is made of a resilient plastic resin.

4. The closure cap according to claim 3, wherein the information displayed on the length of the cylindrical sleeve is selected from the group consisting of printed on, molded and painted on.

5. The closure cap according to claim 4, wherein the resilient cylindrical sleeve has a diameter which is less than the diameter of the dispensing device but sufficient to allow for, upon separation of the first and second ends an expansion of the cylindrical sleeve, a tight frictional fit with an exterior of the dispensing device.

6. The closure cap according to claim 1, wherein the resilient cylindrical sleeve is made of a resilient plastic resin.

7. The closure cap according to claim 6, wherein the information displayed on the length of the cylindrical sleeve is selected from the group consisting of printed on, molded and painted on.

8. The closure cap according to claim 7, wherein the resilient cylindrical sleeve has a diameter which is less than the diameter of the dispensing device but sufficient to allow for, upon separation of the first and second ends an expansion of the cylindrical sleeve, a tight frictional fit with an exterior of the dispensing device.

9. The closure cap according to claim 1, wherein the information displayed on the length of the cylindrical sleeve is selected from the group consisting of printed on, molded and painted on.

10. The closure cap according to claim 9, wherein the resilient cylindrical sleeve has a diameter which is less than the diameter of the dispensing device but sufficient to allow for, upon separation of the first and second ends an expansion of the cylindrical sleeve, a tight frictional fit with an exterior of the dispensing device.

11. The closure cap according to claim 1, wherein the resilient cylindrical sleeve has a diameter which is less than the diameter of the dispensing device but sufficient to allow for, upon separation of the first and second ends an expansion of the cylindrical sleeve, a tight frictional fit with an exterior of the dispensing device.

12. The closure cap according to claim 2, wherein the information displayed on the length of the cylindrical sleeve is selected from the group consisting of printed on, molded and painted on.

13. The closure cap according to claim 2, wherein the resilient cylindrical sleeve has a diameter which is less than the diameter of the dispensing device but sufficient to allow for, upon separation of the first and second ends an expansion of the cylindrical sleeve, a tight frictional fit with an exterior of the dispensing device.
